(19) United States
(12) Patent Application Publication
(10) Pub. No.: US 2018/0053228 A1
(43) Pub. Date: Feb. 22, 2018

(54) SYSTEMS AND METHODS FOR ALLOCATING MOBILE ADVERTISEMENT INVENTORY

(71) Applicant: PCMS Holdings, Inc., Wilmington, DE (US)

(72) Inventor: Janne Aaltonen, Turku (FI)

(73) Assignee: PCMS Holdings, Inc., Wilmington, DE (US)

(21) Appl. No.: 15/545,334

(22) PCT Filed: Jan. 22, 2016
(86) PCT No.: PCT/US2016/014495

§ 371 Date: Jul. 21, 2017

Related U.S. Application Data
(60) Provisional application No. 62/107,015, filed on Jan. 23, 2015.

(51) Int. Cl. G06Q 30/02

(52) U.S. Cl. CPC G06Q 30/0283; G06Q 30/0242; G06Q 30/0247; G06Q 30/0267; G06Q 30/0201

(57) ABSTRACT

Systems and/or methods for determining an effective viewing time of an advertisement displayed on a device such that a price for the advertisement may be based on the effective viewing time may be provided. For example, first movement data based on a first movement of the device may be measured or determined. A time of displaying the advertisement on the device may be measured or determined, for example. During the time of displaying the advertisement, second movement data based on a second movement of the device may be measured and/or determined. The first movement data, the second movement data, and/or the time to an advertisement service may be sent (e.g., to an advertisement service) such that the effective viewing time for the advertisement and/or the price based thereon may be calculated or determined based on the first movement data, the second movement data, and/or the time.

### CROSS-REFERENCE TO RELATED APPLICATION

This application claims priority to U.S. provisional patent application No. 62/107,015, filed Jan. 23, 2015, which is incorporated herein by reference in its entirety.

### BACKGROUND

Today, mobile or web-based advertisements or marketing have become increasingly popular techniques to deliver advertisements or coupons to a user. Currently, advertisement revenue for advertisements or coupons placed on websites (e.g. web-based advertisements or marketing) may be based on one or more of the following different platforms: Cost per Impression (CPM), Cost per Click (CPC), and/or Cost per Action (CPA). In traditional television and radio media-based advertisements or marketing, the typical model for advertising or marketing tends to be a price per second model (e.g., that may be a function of likely audience). Unfortunately, such a price per second model may not be provided or represented properly in mobile or web-based advertisements or marketing.

### SUMMARY

Systems and/or methods for determining an effective viewing time of an advertisement displayed on a device such that a price for the advertisement may be based on the effective viewing time may be provided. For example, first movement data of the device may be measured or determined. In an example, the first movement data may be based on a first movement of the device (e.g., user's interaction with the device) before the advertisement may be displayed or rendered on the device. An advertisement may be rendered. A time of displaying the advertisement on the device may be measured or determined, for example. During the time of displaying the advertisement, for example, second movement data of the device may be measured and/or determined. The second movement data may be based on a second movement of the device (e.g., a user's interaction with the device) during the display of the advertisement. The first movement data, the second movement data, and/or the time may be sent (e.g., to an advertisement service) such that the effective viewing time for the advertisement and/or the price based thereon may be calculated or determined based on the first movement data, the second movement data, and/or the time.

The Summary is provided to introduce a selection of concepts in a simplified form that may be further described below in the Detailed Description. This Summary is not intended to identify key features or essential features of the claimed subject matter, not is it intended to be used to limit the scope of the claimed subject matter. Furthermore, the claimed subject matter is not limited to the examples herein that may solve one or more disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1 illustrates a block diagram of an example architecture of a system that may be provided and/or used as described herein to provide mobile or web-based advertisements or coupons.

FIG. 2-4 depict block diagrams of example devices that may be provided and/or used herein to provide mobile or web-based advertisements or coupons.

FIGS. 5A-B illustrate example methods for delivering a web-based advertisement or coupon using pay or price per second as described herein.

FIG. 6A depicts a diagram of an example communications system in which one or more disclosed examples watches or devices may be implemented and/or may be used with one or more of the example watches or devices described herein.

FIG. 6B depicts a system diagram of an example radio access network and an example core network that may be used within the communications system illustrated in FIG. 6A.

FIG. 6C depicts a system diagram of another example radio access network and an example core network that may be used within the communications system illustrated in FIG. 6A.

FIG. 6D depicts a system diagram of another example radio access network and an example core network that may be used within the communications system illustrated in FIG. 6A.

### DETAILED DESCRIPTION

A detailed description of illustrative embodiments may now be described with reference to the various Figures. Although this description provides a detailed example of possible implementations, it should be noted that the details are intended to be exemplary and in no way limit the scope of the examples described herein.

As described herein, total sales impact of mobile marketing may be estimated to be in the United States (USA) over USD400B according Mobile Marketing Association. Further, related communication (e.g., mobile devices or cellular devices and services associated therewith) spending in United Stets may be close to USD with, for example, a combined annual growth rate of 52%.

In examples, the market (e.g., for communications and devices related thereto) may be, in general, split to Mobile Media Advertisement (MMA), Mobile Direct Response Enhanced traditional (MDR) advertisement and Mobile Content and relationship marketing (Mobile CRM). Table 1 illustrates example market spending.

TABLE !1
!Mobile!Marketing!Communications!Spending!in!United!States!($Millions)!

| | | | | | | | CAGR!2010P |
|---|---|---|---|---|---|---|---|
| ! | 2010! | 2011! | 2012! | 2013! | 2014! | 2015! | 2015! |
| Mobile!Marketing!Investment! | 2,405! | 3,957! | 6,693! | 10,456! | 15,162! | 19,806! | 52%! |
| Mobile!Media!Adv! | 991! | 1,743! | 3,060! | 4,871! | 7,078! | 9,207! | 56%! |
| Mobile!DR!Enhanced!Trad'l!Adv! | 166! | 336! | 669! | 1,312! | 2,174! | 2,912! | 77%! |
| Mobile!CRM! | 1,248! | 1,878! | 2,964! | 4,273! | 5,910! | 7,686! | 44%! |

In examples, Mobile Media Advertisements may be sold as audience based (e.g., cost-per-thousand views or impressions) or on a performance based (e.g., pay per-click or pay per transactions). MDR may be related to integrate an advertisement campaign with an other media such as prompting consumers to opt-in to Short Message Service (SMS) alerts, to call a 1-800 number using a Quick Response (QR) code to access information or additional information. Further, according to an example, Mobile CRM may be related to promoting marketers content in web-pages such as user-generated web-pages and/or other media.

Currently, as described herein, advertisement revenue for advertisements that may be provided or placed on websites may be based on three different platforms: Cost per Impression (CPM). Cost per Click (CPC), or Cost per Action (CPA).

Additionally, for example, in traditional television and radio media, the model for advertising may be a price per second model that may be a function of a likely audience. As described herein, the price per second model may not be represented or provided via Internet or web-based advertising and/or in mobile advertisement.

According to examples (e.g., such as based on advertisement reports), mobile advertisement conversion rates may be lower than other devices such as desktop or Personal Computer (PC) advertisement rates. Table 2 illustrates examples of advertisement conversion rates for devices.

TABLE 2

| | Total | | Mobile Subtotal | |
|---|---|---|---|---|
| | PC | Mobile | Smartphone | Tablet |
| Budget Share* | 87% | 13% | 7% | 6% |
| Click Share | 82% | 18% | 10% | 7% |
| Clicks yielded per budget | 0.95 | 1.33 | 1.48 | 1.16 |
| dollar (Derived) | | | | |
| Cost per click | 0.77 | 0.56 | 0.50 | 0.63 |
| cost per weighted click | 0.811 | 0.420 | 0.341 | 0.544 |
| (Derived) | | | | |
| Click-thru-rate (CTR) | 0.022 | 0.04 | 0.051 | 0.032 |
| Implied Weighted eCPM | $371.80 | $97.36 | $66.90 | $170.03 |
| (Derived) | | | | |

Unfortunately, as described herein, the cost per click model may not be working for mobile or web-based advertisement (e.g., as shown in Table 2). As such, other models may be used for mobile or web-based advertisement. For example, an advertisement business model for Internet based on cost per second (CPS) may be used. In such a model, an advertisement format may be provided and/or used where the bidding and pricing may be based on duration of the advertisement in which is shown to the consumer.

For example, a method for web-based advertising using a cost-per-time scheme may include providing a web page to a browser, sending an advertisement to the browser for display on the web page where the browser displays the advertisement at least while an upload of data may be in progress, determining a time of an upload of data to the web server, and storing the time of the upload of data where the stored time may be associated with the advertisement such that an advertiser may be able to be charged for the display of the advertisement based on the time of the upload of data. Unfortunately, such a method may determine the advertisement display time during an upload (or even a download), but not at other times. Additionally, in such a method, the revenues may not be predictable for the advertisement system operator since the download time varies and is function of bandwidth available for the customers computing device.

Additionally, in an example, a method for providing an effective cost per second (eCPS) may be used to track and/or calculate advertising revenue (e.g., on the Internet). Such an eCPS method may be a function of user actions such as mouse roll-over, click, rewinding the ad, pausing the ad, playing the ad, entering info on the ad. Unfortunately, such a method may not verify that the advertisement is really being watched. For example, an advertisement may be shown in a web page but the user may have left the window open and may be doing something else or may not even be near or around the device. This may lead to unfair billing towards advertisers and, thus, may destroy grounds for or may not enable implementing efficient cost per second advertisement systems.

As such, systems and/or methods described herein such as price per second or cost per second, and/or the like may be provided that may improve mobile or web-based advertising. For example, advertisements may be delivered to a user (e.g., via his or her device) as banners, in-app advertisements, popups, videos, images and/or the like. In an example (e.g., as soon as the advertisement may be delivered and rendered in the device such as on a display or screen thereof), a timer may be used and started. The timer may be stopped, for example, if or when the advertisement may be removed from the screen of the terminal. The measured time of the possible viewing time (e.g., that may be the time between the timer starting and stopping) may be a first parameter (ta). The first parameter (ta) may be a factor or parameter that may be used to determine advertisement related pricing. Further, based on examples herein, a device may include device or mobile terminal sensors such as accelerometer, magnetometer, gyroscope, and/or the like. The sensors may be used to measure movements (e.g., the first and/or second movement and/or the third movement) of the device (e.g., or mobile terminal). The movements of the device may be used to classify movements to categories such as the device may be stationary on a table, the device may be being carried by persons in hand and used, the device may be placed in a pocket of a user, the device may be being observed (e.g., watched for instance), the movements of the user (e.g., of the device) may correlate with a content in the device. The movement categories may be used to determine a weighting factor (wa). A value or range of values for the weighting factor (wa) may be assigned to or associated with the categories or classified movements. For example, a weighting factor of 0.7 to 1.0 could be given, for example, if the movement category (e.g., the first and/or second movement may have a movement category that) may correspond to device being observed by the user. A weighting factor of 0 to 0.3 could be given if the movement category (e.g., the first and/or second movement may have a movement category that) may correspond to the device being in a pocket (e.g., thus, indicating that the terminal may not be being watched). A weighting factor of 0.3 to 0.7 may be given if the device may be, based on the movement data (e.g., the first and/or second movement may have a movement category that may indicate that the device may be) on the table in an orientation where the display surface is facing up (i.e. not towards a table). As such, such sensors in the device may be used to determine a weighting factor (wa). The weighting factor (wa) may be used to weight the measured time (ta) or the first parameter to derive a basis (p) for billing the actual viewing time of the advertisement. For example, the basis for billing the actual viewing time of an advertisement on a device such as a mobile device may be as follows p=ta×wa (i.e. ta multiplied with or by wa). In such an example, a pay per second business model and method of billing using such a method may be feasible as described herein.

Systems and/or methods for providing such a pay per second business model as described herein may be provided as follows. For example, a determination may be made for an effective viewing time (e.g., which may be separate and/or in combination with an actual viewing time as described herein) of an advertisement in a display of a device such as a mobile or smart phone. According to an example, to make such a determination, first movement data of the device may be measured, for example, using a sensor of the device. The first movement data may be measured during consuming a media such as video or web page, during use of an application, during play of a game, and/or the like, for example, to determine a reference movement data for the device in use. An advertisement may be rendered on or with the device (e.g., via a display or on a screen thereof). The rendering may interrupt, for example, media consumption such as watching a movie. A duration of time may be measured for or of showing the advertisement on the device (e.g., this may be performed or provided using a timer as described). Further, in an example (e.g., during the time of showing the advertisement), second movement data of the device may be measured, for example, using or with the sensor of the device. The second movement data may be measured during the time the advertisement may be rendered on the device (e.g., the screen). According to an example, the first movement data, the second movement data, and/or the duration of the time of showing the advertisement may be used to calculate a weighting factor that may be used (e.g., with the duration measured by a timer) to calculate the effective viewing time of the advertisement. As an example, a weighting factor (wa) may be set to 0.7 to 1.0 if the first movement data and the second movement data may be similar (e.g., may have similar movement categories) indicating that the user may be observing the device with same level of interest during the consumption of a media, for example, and during the time the advertisement may be being rendered. Similarity between the first movement data and the second movement data may be determined using for example statistical methods such as cross correlation or neural network algorithms. A weighting factor of 0 to 0.3 may be used, for example, or given if the first movement data and the second movement data show little or no correlation (e.g., they may not be part of the same movement categories). As an example, the first movement data might indicate that person may holding the device in the hand in a position enabling the user to see the terminal and the second movement data indicates that the terminal may be placed in the table upside down. According to an additional example, a weighting factor of 0.3 to 0.7 may be provided and/or used or given if there may be an intermediate correlation (e.g., the movement categories of the first and/or second movement data may overlap or be similar but not the same) between first movement data and the second movement data. The effective viewing time of the advertisement may be used to measure a cost of the advertisement. As an example the effective viewing time may be calculated with same or similar equation as above i.e. p=ta*wa.

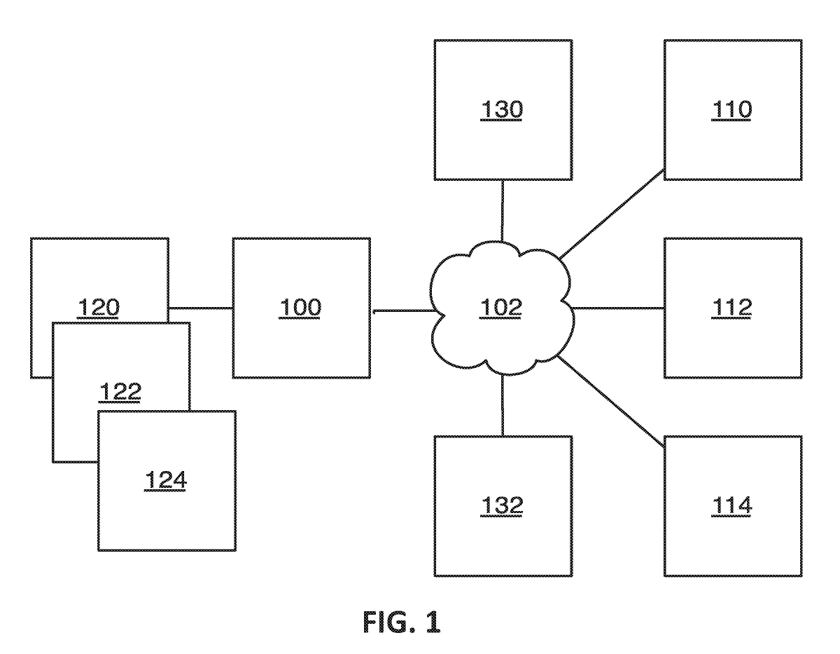

FIG. 1 depicts an example architecture of an environment that may be used to provide price per second advertisement models as described herein. Advertisers 120, 122, 124 such as brand owners, merchants, service provides, application developers, and/or or the like may want to advertise their products (or services) to consumers via a device such as customer device or terminals 110, 112, 114. According to an example, the advertisers 120, 122, 124 may provide related advertisement material such as images, text, videos, audio or a combination thereof to an advertisement service provider 100. For example, the advertisers 120, 122, 124 may have and/or included one or more devices, servers, databases computers, and/or the like that may provide and advertisement (e.g., collectively that may include text, videos, audio, and/or the like that may be part of the advertisement) and/or text, video, audios, and/or the like the advertisers 120, 122, 124 may want the advertisement provider 100 to use to generate an advertisement. For example, the advertisers 120, 122, 124 via the one or more devices, servers, databases, computers, and/or the like may be in communication with the advertisement service provider 100 such that the advertisers 120, 122, 124 may send the advertisements and/or the text, video, audio, and/or the like associated therewith (e.g., that may be part of the advertisement) to the advertisement service provider 100.

The advertisement service provider 100 may include one or more devices, databases, servers, computers, and/or the like. The advertisement service provider 100 may receive the advertisements and/or the text, video, audio, and/or the like associated therewith via the one or more devices, databases, servers, computers, and/or the like and may send or publish the advertisements and/or the text, audio, video, and/or the like to users (e.g., via a connection such as a network connection 102 to a network 600 and/or the Internet) using the one or more devices, database, servers, computers, and/or the like.

In an example, the advertisers 120, 122, 124 may agree on pricing, delivery channels, delivery rules, and/or the like related to the advertisements with the advertisement service provider 100. Example of the rules may be geography, demographics, age, gender, consumer profile, delivery time and dates, allocated funds for the advertisement campaign, business rules related to billing and/or the like.

The advertisements (e.g., including the text, audio, and/or the like) may be sent to a device (e.g., a computer, mobile device, and/or the like such as 110, 112, 114) and/or may presented on, for example, a website 130 and/or on applications 132 in a multiple formats such as banners, popups, sidebar, in-app ads, flash animations, videos, and/or the like. Based on examples, a code snippet such as java script may be added to the code such as Hyper Text Markup Language (HTML) code of the website 130 to provide or enable display of the advertisement in the website 130 by the advertisement provider 100. For example (e.g., in an example of providing advertisements to an application such as the application 132 (e.g., an iPhone®, App, an Android® App, and/or the like)), a developer may insert one or more lines of codes or function calls in the application during the development phase. In an example, as the function call or code that may be related to advertisement may be called by the application 132, the advertisement may be delivered from the advertisement service provider 100 to the application 132 used by a user.

For example, the advertisements may be rendered to consumers or users via the devices such as the consumer devices or terminals 110, 112, 114, for example, while accessing website 130 with a browser of the terminal or using an application 132. The devices 110, 112, 114 may be mobile devices, smart phones, tablets or computers in examples as described herein.

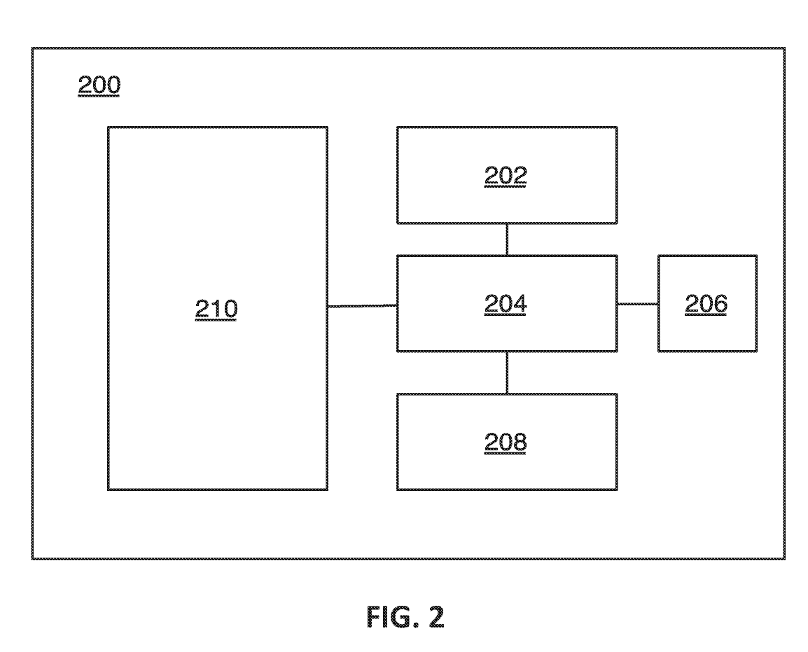

FIGS. 2-4 illustrate an example device (e.g., that may be 110, 112, 114) such as smart phone, portable computing device, table, electronic pad, and/or the like that may be used to provide advertisements using a cost per second such as a price per second model according to examples herein. As shown in FIG. 2, a device 200 may include or have a display 210 to be used for rendering visual content (e.g., the advertisement) to a user or consumer.

The display 210 may be controlled by a processor 204 such as a Central Processing Unit (CPU) that may be included in the device 200. The device 200 may further include memory 202. In examples, as described herein, software, instructions (e.g., computer executable instructions), business rules, settings, and/or the like may be stored in the memory 202 of the device 200 and executed by the processor 204 (e.g., the processor 204 may receive or fetch the software, instructions, rules, settings, and/or the like or and may execute them). In an example, the processor 204 may receive the advertisement from memory 202 and may render the advertisement or provide it to the display 210. The device 200 may further include a set of sensors 208 such as an accelerometer, a magnetometer, a gyroscope, and/or the like that may be used to detect motion, tilt, and/or other properties of the device 200 (e.g., the movement data and/or the like such as the first movement data and/or the second movement data that may be used to determine or calculate and effective viewing time or actual viewing time as described herein). In an example, the device 200 may include a communication interface 206 such that the device 200 may be configured to communicate (e.g., wirelessly or wired) via the communication interface 206 (e.g., with the advertisement service provider 100).

In examples, the processor 204 may be used to calculate the effective viewing time ad described herein and/or the weighting factor using the movement data collected and/or received from the sensors 208.

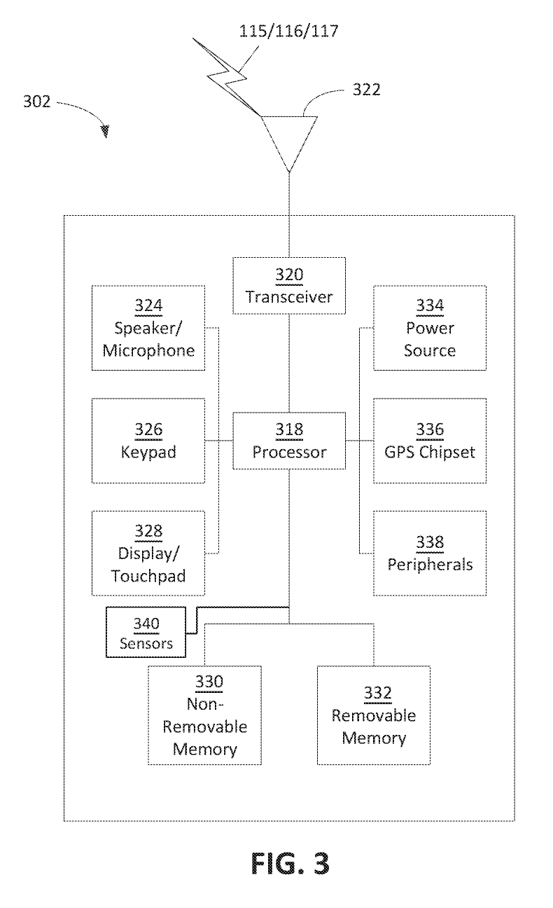

As shown in FIG. 3, a device 302 (e.g., that may be 110, 112, 114) may be provided to calculate viewing time and/or display advertisements as described herein. The device 302 may include one or more components. The components may be configured to execute an application such as the application 132 and/or a web browser such as the website 130 that may provide an advertisement as described herein. The components of the device may include a processor 318, a transceiver 320, a transmit/receive element 322, a speaker/microphone 324, a keypad 326, a display/touchpad component or interface 328 (e.g., an interface for the display or screen such as the display 210), non-removable memory 330, removable memory 332, a power source 334, a global positioning system (GPS) chipset 336, and other peripherals 338 and one or more sensors 340 for measuring movement data such as an accelerometer, a magnetometer, a gyroscope, and/or the like for measuring acceleration of a terminal. It may be appreciated that the device may include any sub-combination of the foregoing elements while remaining consistent with an embodiment. Also, examples contemplate that other devices and/or servers or systems described herein, may include some or all of the elements depicted in FIG. 3 and described herein.

The processor 318 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 318 may perform signal coding, data processing, power control, input/output processing, and/or any other functionality that may enable the device to operate in a wireless environment. The processor 318 may be coupled to the transceiver 320, which may be coupled to the transmit/receive element 322. While FIG. 3 depicts the processor 318 and the transceiver 320 as separate components, it may be appreciated that the processor 318 and the transceiver 320 may be integrated together in an electronic package or chip. The processor 318 may execute the methods described herein (e.g., to calculate effective viewing time and/or actual viewing time) and/or to provide or display an advertisement on the device.

The transmit/receive element 322 may be configured to transmit signals to, or receive signals from, another device (e.g., the user's device and/or a network component such as a base station, access point, or other component in a wireless network) over an air interface 315. For example, in one embodiment, the transmit/receive element 322 may be an antenna configured to transmit and/or receive Radio Frequency (RF) signals. In another or additional embodiment, the transmit/receive element 322 may be an emitter/detector configured to transmit and/or receive Infra Red (IR), Ultra Violet (UV), or visible light signals, for example. In yet another or additional embodiment, the transmit/receive element 322 may be configured to transmit and receive both RF and light signals. It may be appreciated that the transmit/receive element 322 may be configured to transmit and/or receive any combination of wireless signals (e.g., Bluetooth, Wireless Local Area Network (WiFi/WLAN), and/or the like).

In addition, although the transmit/receive element 322 may be depicted in FIG. 3 as a single element, the device may include any number of transmit/receive elements 322. More specifically, the device may employ MIMO (multiple input, multiple output) technology. Thus, in one example, the device may include two or more transmit/receive elements 322 (e.g., multiple antennas) for transmitting and receiving wireless signals over the air interface 315.

The transceiver 320 may be configured to modulate the signals that may be transmitted by the transmit/receive element 322 and to demodulate the signals that are received by the transmit/receive element 322. As noted above, the device may have multi-mode capabilities. Thus, the transceiver 320 may include multiple transceivers for enabling the device to communicate via multiple radio access technologies (RATs), such as UTRA and IEEE 802.11, for example.

The processor 318 of the device may be coupled to, and may receive user input data from, the speaker/microphone 324, the keypad or touch interface 326, and/or the display/touchpad 328 (e.g., a liquid crystal display (LCD) display unit or organic light-emitting diode (OLED) display unit). The processor 318 may also output user data to the speaker/microphone 324, the keypad 326, and/or the display/touchpad 328. In addition, the processor 318 may access information from, and store data in, any type of suitable memory, such as the non-removable memory 330 and/or the removable memory 332. The non-removable memory 330 may include random-access memory (RAM), read-only memory (ROM), a hard disk, or any other type of memory storage device. The removable memory 332 may include a subscriber identity module (SIM) card, a memory stick, a secure digital (SD) memory card, and the like. In other embodiments, the processor 318 may access information from, and store data in, memory that may not be physically located on the device, such as on a server or a home computer (not shown). The removable memory 330 and/or non-removable memory 332 may store a user profile or other information associated therewith that may be used as described herein.

The processor 318 may receive power from the power source 334, and may be configured to distribute and/or control the power to the other components in the device. The power source 334 may be any suitable device for powering the device. For example, the power source 334 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 318 may also be coupled to the GPS chipset 336, which may be configured to provide location information (e.g., longitude and latitude) regarding the current location of the device. In addition to, or in lieu of, the information from the GPS chipset 336, the device may receive location information over the air interface 315 from another device or network component and/or determine its location based on the timing of the signals being received from two or more nearby network components. It may be appreciated that the device may acquire location information by way of any suitable location-determination method while remaining consistent with an embodiment.

The processor 318 may further be coupled to other peripherals 338, which may include one or more software and/or hardware modules that provide additional features, functionality and/or wired or wireless connectivity. For example, the peripherals 338 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

The processor 318 may be further coupled to the one or more movement data sensors 340 to collect or receive measurement data (e.g., the movement data such as the first, second, and/or third movement data) from the sensors 340. The collected measurement data can be processed and/or stored as it is in the non-removable memory 330 or removable memory 332 as raw data or as processed data for further usage as described herein.

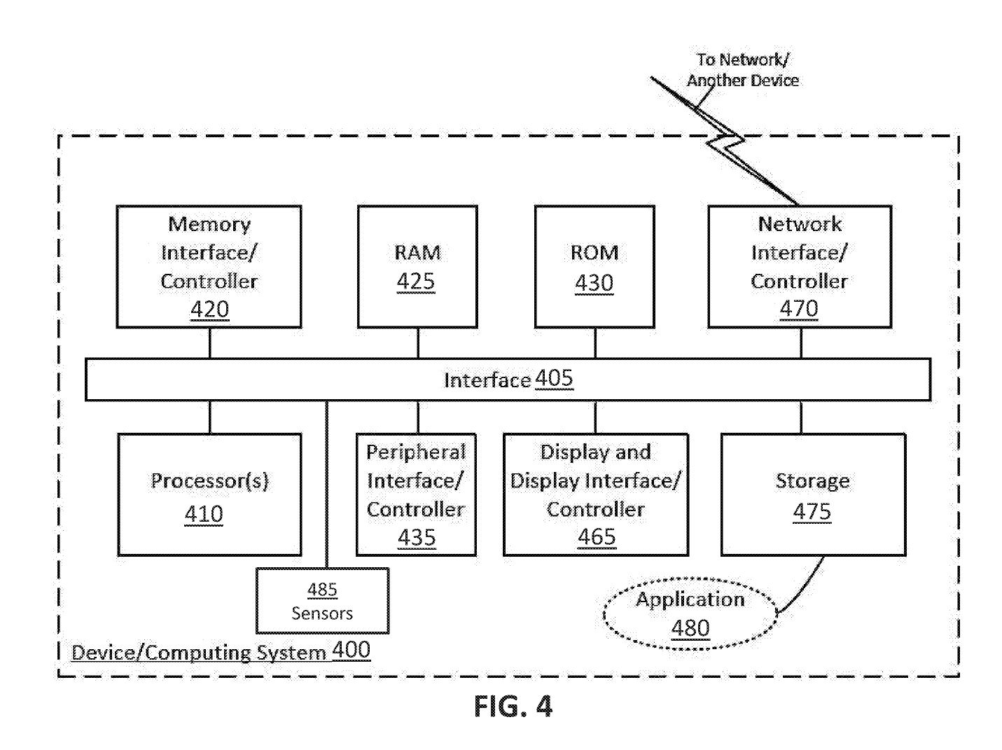

As shown in FIG. 4, the device 400 (e.g., which may be 110, 112, 114, 200, and/or 302 or similar thereto) may include one or more components. As described herein, the components of the device may be capable of executing a variety of computing applications 480 such as the application 132 and/or a web browser that may display the website 130 that may provide an advertisement as described herein. The computing applications 480 may be stored in a storage component 475 (and/or RAM or ROM described herein). The computing application 480 may include a computing application, a computing applet, a computing program and other instruction set operative on the device 400 to perform at least one function, operation, and/or procedure as described herein. According to an example, the computing applications may include the methods and/or applications described herein. The device may be controlled primarily by computer readable instructions that may be in the form of software. The computer readable instructions may include instructions for the device for storing and accessing the computer readable instructions themselves. Such software may be executed within a processor 410 such as a central processing unit (CPU) and/or other processors such as a co-processor to cause the device to perform the processes or functions associated therewith. The processor 410 may be implemented by micro-electronic chips CPUs called microprocessors.

In operation, the processor 410 may fetch, decode, and/or execute instructions and may transfer information to and from other resources via an interface 405 such as a main data-transfer path or a system bus. Such an interface or system bus may connect the components in the device and may define the medium for data exchange. The device may further include memory devices coupled to the interface 405. According to an example embodiment, the memory devices may include a random access memory (RAM) 425 and read only memory (ROM) 430. The RAM 425 and ROM 430 may include circuitry that allows information to be stored and retrieved. In one embodiment, the ROM 430 may include stored data that cannot be modified. Additionally, data stored in the RAM 425 typically may be read or changed by the processor 410 or other hardware devices. Access to the RAM 425 and/or ROM 430 may be controlled by a memory controller 420. The memory controller 420 may provide an address translation function that translates virtual addresses into physical addresses as instructions are executed. In examples, the processor 410 may generate and/or calculate the effective viewing time and/or actual viewing time of an advertisement and/or provide an advertisement (e.g., to the display) according to examples herein

In addition, the device 400 may include a peripherals controller 435 that may be responsible for communicating instructions from the processor 410 to peripherals such as a printer, a keypad or keyboard, a mouse, and a storage component. The device 400 may further include a display controller 465. The display/display controller 865 may be used to display visual output generated by the device. Such visual output may include text, graphics, animated graphics, video, or the like. The display controller associated with the display (e.g., shown in combination as 465 but may be separate components) may include electronic components that generate a video signal that may be sent to the display. Further, the device may include a network interface or controller 470 (e.g., a network adapter) that may be used to connect the device to an external communication network and/or other devices (not shown).

In addition, the device 400 may include one or more motion or movement sensors 485 such as an accelerometer, a magnetometer, a gyroscope, and/or the like for detecting the motion (e.g., movement data) of the device 400 as described herein. In examples, the data (e.g., movement or motion data including the first, second, third, and/or the like movement data) may be stored in the RAM 425 or storage 475 of the device 400. For example, the processor(s) 410 may be coupled (e.g., via the interface 405) to one or more motion or movement sensors 485 to collect or receive measurement data (e.g., the movement data such as the first, second, and/or third movement data) from the sensors 340. The collected measurement data can be processed and/or stored as it is in the RAM 425 or storage 475 as raw data or as processed data for further usage as described herein.

As described herein, the systems and/or methods for providing the cost per second advertisement may be implemented or provided in a device or mobile device environment (e.g., such as via an iOS or iPhone application) that may be provided on the devices (e.g., 110, 112, 114, 200, 302, and/or 400 described herein). For example, in a device (e.g., the mobile phone or device, smart phone, and/or the like such as 110, 112, 114, 200, 302, and/or 400 described herein) environment, developers may have access to data such sensor data (e.g., the first and/or second movement data). The sensor data (e.g., the first and/or second movement data) may include orientation of a device, shaking or movement of the device in one or more directions, acceleration of the device, and/or any other movement of the device. In examples, the sensor data (e.g., the first and/or second movement data) may be accessed for example, using or via one or more of the following classes: a UIDevice class that may be used to detect an orientation of the device, a UIEvent class object that may be used to detect shaking of the device, or a core motion framework that may deliver motion events directly to an application that may be requesting them, and/or any other suitable classes, frameworks, events, and/or the like that may provide sensor data. Motion events may include detecting that an accelerometer value (of an X, Y or Z axis accelerometer) reaches a predetermined value or threshold or for example detecting that the terminal may be in a particular orientation or the terminal may have been moved based on a pattern (e.g., a defined or certain pattern).

According to an example, one or more motion events (e.g., core motion events) that may be recorded, provided, or measured by the sensor (e.g., and may be included in the sensor data including the first movement and/or second movement data) may be represented by one or more (e.g., three) data objects each of which may encapsulate one or more measurements. For example, the motion events may be represented by one or more of the following data objects (e.g., core motion software elements/objects): a CMAccelerometerData object that may capture acceleration along each of the (e.g., three) spatial axes, a CMGyroData object that may capture a rate of rotation around each of the spatial axes, a CMDeviceMotion object that may encapsulates one or more different measurements including attitude, rotation rate, acceleration, and/or the like. In examples, each of the information that may be included in such data objects may be included in the sensor data or the first and/or second movement data. For example, the sensor data or the first and/or second movement data may include acceleration of the device (e.g., including along one or more of the spatial axes), a rate of rotation of the device (e.g., including along one or more of the spatial axes), altitude, and/or the like.

In an example, a CMMotionManager class may be used to provide and/or access such sensor data and may be a central access point for the core motion (e.g., acceleration, altitude, rotation rate, orientation, movement, and/or the like of the device). A developer may create an instance of the class, may specify an update interval (e.g., a time at which or interval at which to record the motion of the device), may request that updates start, and/or may handle motion events as they may be delivered. In an example, application may create a single instance of the CMMotionManager class (e.g., as multiple instances of this class may affect the rate at which an app receives data from the accelerometer and gyroscope).

Further, data-encapsulating classes may be used to access such sensor data. For example, data-encapsulating classes of the core motion classes or software classes may be used. The data-encapsulating classes may be subclasses of a CMLogItem, which may define a timestamp such that motion data may be tagged with a time and logged to a file. In an example, an application may compare the timestamp of motion events with earlier motion events to determine an update interval between the events. In examples herein, the first movement data could be considered to include and/or may include, for example, the data, which may be being collected during use of the device or terminal to consume media without advertisements. The second movement data could be considered to include and/or may include the data, which may be being collected during use of the device or terminal while the advertisements may be being rendered. According to an example, the interval between the events or movements (e.g., use before advertisements and/or use after advertisements may be being rendered) may be the time between the movements. For example, the first and the second movement data may, for example, last 0-5 seconds (e.g., an example interval) of the movements, may, for example, last 0-10 seconds (e.g., an example interval) of the movements, or may, for example, last minute or longer (e.g., an example interval) of the movements.

According to an example (e.g., for each of the data-motion types described herein), the CMMotionManager class may offer one or more of the following approaches or method for obtaining motion data or sensor (e.g., that may be included in the first and/or second movement data): pull where an application may request that updates start and then may periodically sample the most recent measurement of motion or sensor data that may be or included in the first and/or second movement data, push where an application may specify an update interval and may implement a block for handling the motion or sensor data that may be or may be included the first and/or second movement data and may then request that updates start and pass core motion using an operation queue and the block, and/or the like. Core motion objects may deliver each update of the data to the block, which may execute as a task in the operation queue in an example.

Pull, according to one example, may be used or recommended for applications such as games. Pull may be generally more efficient and may use less code. In pull mode, an application may perform or take an initiative when to request motion data. For example, in pull mode, the application may be constantly connected to and/or may constantly ping the sensors, storage (e.g., RAM and/or any other storage component in the device), and/or processor (e.g., in the device) such that whenever a change occurs or movement may be recorded or changed, the application may be notified immediately by the device (e.g., the sensors and/or processor). This may be beneficial in a case where reference data of“normal” usage i.e. first movement data may be determined with sufficient accuracy. In such an example or case, the application may stop requesting the motion data. Push may be used or appropriate for data-collection apps and similar apps that may not miss a single sample measurement. In an example, in push mode, the application may periodically ping or connect to the sensors, storage (e.g., RAM and/or any other storage component in the device), and/or processor for movement data such that the application may be updated with the movement data when it upon such connection. Push mode may be beneficial during the time the advertisement may be rendered to enable collection of all possible data during (typically short) time of showing an advertisement. Both pull and push may have benign thread-safety effects, for example, with push, a software block may execute on the operation-queue's thread whereas with pull, the core motion may not interrupt threads.

Similar functionalities and structures may be found in other operating systems as well such as Android-based operating systems, windows-based operating systems, and/or the like (e.g., that may be used on Android and/or Windows phones). For the examples herein, the key functionality that may be used from such operating systems may include an application programing interface (API) or similar interface, class, framework, data object, and/or the like that may enable recording and access of sensor data or motion data (e.g., that may be or may be included in the first and/or second movement data) using the device.

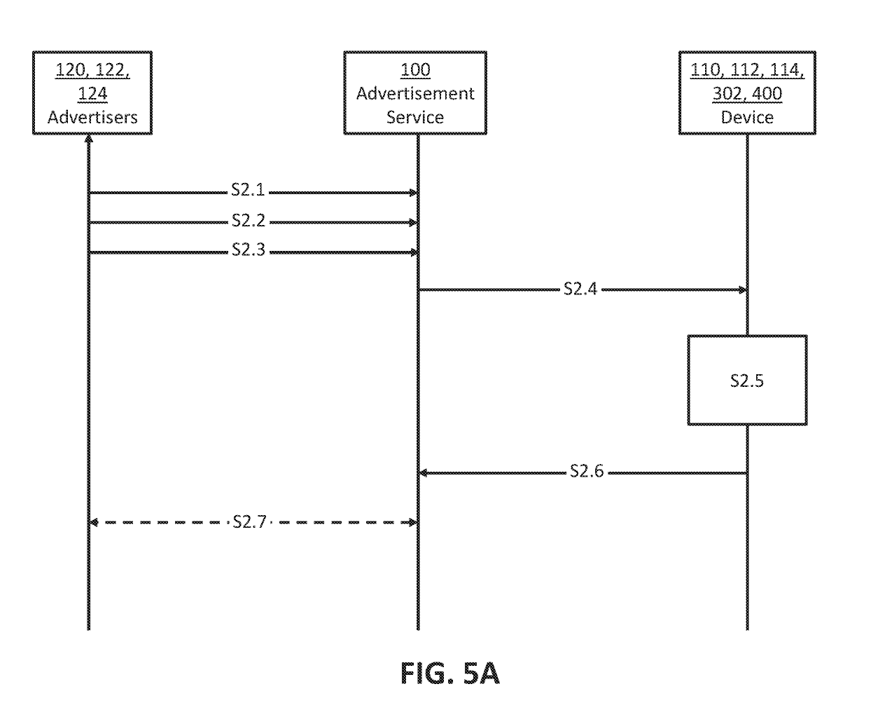

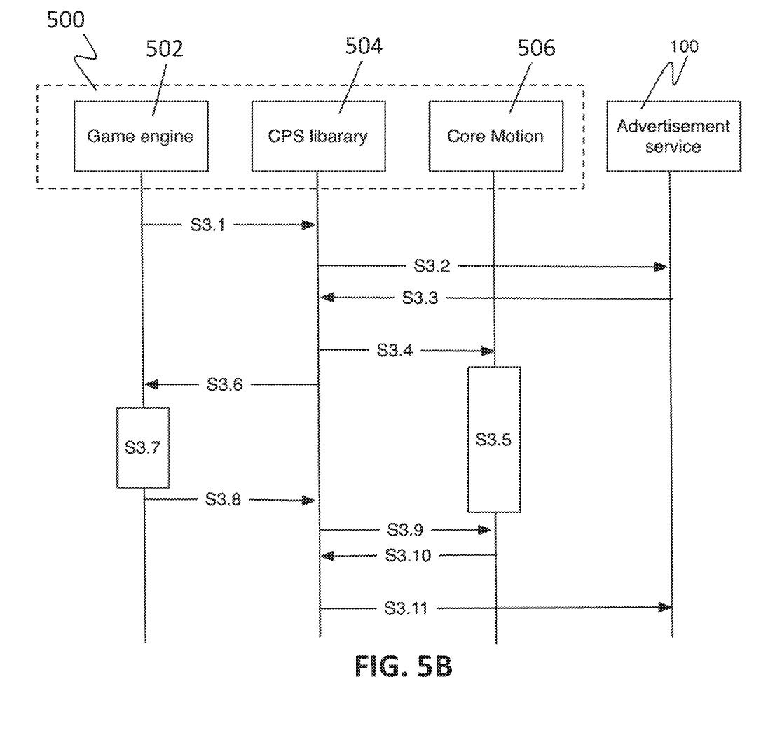

FIGS. 5A-B illustrate a flow diagram or chart of example methods for delivering a web-based advertisement or coupon using pay or price per second as described herein. As described herein, at S2.1, an advertiser (e.g., 120, 122, 124) may upload an advertisement to a system (e.g., a device that may be include the components of the devices described herein such as 302 and/or 400). In an example, the advertisement may include audio, video, text, pictures, and/or the like that may be displayed on a device (e.g., 110, 112, 114, 302, 400).

In examples, the advertiser may create targeting criteria for the advertisement (e.g., uploaded or sent in S2.1). In an example, the targeting criteria may be associated with which target group (e.g., an audience) and target content (e.g., the media playing on the device, application, site, and/or the like) to which to serve the advertisement. Examples of the targeting criteria may include gender, age, geographical location, historical content usage information, time of the year, and/or the like. Further, the targeting criteria may associate the advertisements with a particular type of content (e.g., movies or particular movies, music, and/or the like) or to particular applications such as a game, social application, and/or the like. In an example, the criteria may be sent to the advertisement service at S2.2. The criteria may be stored with the advertisement uploaded or sent at S2.1 in examples.

Further, according to an example, the advertiser may define a budget for advertisements and/or may determine a price per second for the advertisement with the advertisement service. For example, the advertisers may define a budget for the advertisements and may agree on a price per second for the advertisement showing and may send such information to the advertisement service at S2.3. Additionally, at S2.3, the advertisers may allocate funds to the advertisement campaign from which a price per second or budget may be deducted from for an advertisement that may be served to a device as described herein. According to an example, S2.1-S2.3 may be repeated for plurality of advertisers each uploading one or more advertisements (and creating advertisement campaigns) as described herein.

At S.4, the advertisement service provider may send or serve the advertisement to a device or terminal (e.g., this may also be shown in S3.3 in FIG. 5B). In an example, the advertisement service provider may send or serve the advertisement to the device or terminal in response to a request for the advertisement from the device or terminal (e.g., this may be shown in S3.2 in FIG. 5B and may be started at S3.1 in an example). In examples, the served advertisement may be selected from a pool of advertisements. Further, the served advertisement may be selected based on the criteria associated with the advertisement and/or the device or user of the device meeting the criteria.

At S.5, the device may display the advertisement (e.g., as described in S). Further, at S.5, executable code that may be installed on the device may be performed or executed. For example, the device or terminal requesting advertisement may have an executable code installed (e.g., either embedded in an application or a separate application such as Java script or software elements in the operating system) that may collect or measure the first movement data that may be based on a first movement of the terminal during normal usage and the second movement data that may be based on a second movement of the device during the time the advertisement may be rendered or displayed on the device. In an example, at S.5 the device may execute the code to collect the first movement data prior to or before rendering the advertisement and may collect the second movement data after rendering the advertisement. In additional examples, the first movement data may be collected prior to S2.5. For example, the executable code may be performed or executed prior to S2.5. Further, in examples, S2.5 may include the functions and/or actions described in S3.4-S3.10 described in FIG. 5B.

As described herein, the movement data (e.g., the first and second) may be used to determine effectiveness of the advertisement in the application. For example, based on the movement data (e.g., that may be used to calculate the weighting factor wa) and/or a viewing time ta (e.g., a time in which the advertisement may be displayed), it may be determined that the advertisement may not have been observed and/or may have been at least partially observed. To make such a determination, in an example, the movement data (e.g., the first and/or second) or motion data and the time or time period of the advertisement being displayed may be sent to advertisement service at S2.6 for analysis purposes (e.g., such that the advertisement service may determine the effective viewing time and/or calculate advertising rates as described herein such as to measure or determine the weighting factor and multiplying that by the measured time or time the advertisement may be displayed).

The effectiveness of the viewing may be used to determine amount of funds deducted from the advertiser, which may be performed at S2.7. In an example, if effectiveness (weighting factor) may 1.0 a full amount related to per second price may be deducted from the advertiser's funds. If effectives may be, for example 0.1, 10% of amount related to per second price may be deducted from the advertiser's funds.

FIG. 5B illustrates an example method related to arrangement of the pay per second advertisement delivery library function when integrated as part of an application 500 (e.g., software such as a game) that may run and/or be executed on a device (e.g., 110, 112, 114, 302, 400, and/or the like). In an example, the application 500 may be similar to the application 480 described in FIG. 4. The application 500 may include an engine 502 such as a game engine (i.e. the actual application or game and related code/binary) According to an example, the developer such as the game developer may include a set of rules therein associated with or indicative of when to call and present advertisements in the application or game. According to an example, the advertisements may be called for example before a user beings or starts interacting with or playing the application or game, between, for example, levels or pauses in the application or game, and/or the like. Additionally the application may be reading application such a e-reader, a video application for rendering videos, a web browser, a music application for playing music, and/or the like.

As shown, at S3.1, the engine 502 may call or send a request to a cost per second advertisement library function 504 (e.g., the CPSlibrary). The library function 504 may be configured to communicate with advertisement service 100 to get relevant advertisement content according to an example.

At S3.2 the library function 504 may request for an advertisement such as image to be displayed in the application or game such as overlay to the application or game. In an example, at S3.3, the advertisement service may return the image (e.g., which may be received by the device and rendered thereon) and parameters related to the image such as instructions to collect actual viewing time information (e.g., using a timer as described herein) while displaying the advertisement. In an example, the parameters may include timings (t₀, t₁, t₂, t₃) for measuring and collection movement data. Alternatively or additionally, S3.2 and S3.3 may be performed or done, for example, before the engine may send a request to the library function 504. In such an embodiment, the image and instructions may be cached in memory of the device.

According to an example, at S3.4, the library function 504 may send a function call using or according to a class call such as the CMMotionManager to a core motion framework 506. This may be performed or done via push (or pull in additional examples) such that the motions may be collected independently and time stamped. Based on examples, the motion collection task (e.g., measuring the first and/or second movement data) may be performed and/or may take place at, as, or during S3.5. In an example, during S3.5, accelerometer data (e.g., the first and/or second movement data) may be collected with defined frequency (e.g., motion collection may be performed or done between times t₀-t₃, for example, which may be measured via a timer).

At S3.6, the library function 504 may configure the engine to render an advertisement on the device (e.g., on the display or screen of the device). The advertisement may be configured to be shown or displayed, for example, at or in S3.7 between times t₁-t₂. This time may be, in an example, a first parameter.

In S3.8, the engine 502 releases the screen and the user may continue to interact with the application (e.g., may continue to play the game). In S3.9, the library function 504 may request and may receive in S3.10 motion data (e.g., the first, second and/or third movement data) that may be related to time period of t₀-t₃. This motion data and the time or time period may be sent to advertisement service 100 at S3.11 for analysis purposes (e.g., such that the advertisement service may determine the effective viewing time and/or calculate advertising rates as described herein such as to measure or determine the weighting factor and multiplying that by the measured time or time the advertisement may be displayed). According to an example, the motion data that may be used to determine interaction of the user during display of the add (e.g., the second movement data) may be in the time period of t₁-t₂ (e.g., which may be between t₀-t₃). According to examples herein, the time period t1-t2 may be set by the parameter that may be received from the advertisement service 100 in S3.3 and/or the time period may be determined based on interaction of user with the advertisement. The period may be, for example, extended if the user elects to receive additional information on the advertisement. The period may be, for example, reduced if the user indicates not to see the advertisement fully (e.g., in case of video advertisement the user may elect to close the advertisement and resume to the application). Additionally, in an example, the motion data that may be used as normal movement or a metric of the use of the device before the advertisement may be displayed or rendered (e.g., the first movement data) may be in the time period before of t₁-t₂ (e.g., before the time period or time or duration of time measured when the advertisement may be displayed or rendered). Additionally, in an example, the motion data that may be used as normal movement or a metric of the use of the device after the advertisement may be displayed or rendered (e.g., third movement data that may be based on a third movement) may be in the time period after t₁-t₂ (e.g., after the time period or time or duration of time measured when the advertisement may be displayed or rendered). The motion data (e.g., first and/or second movement data) may be used to detect if the device may have been kept in hand or if it was set a side to table during the advertisement. The motion data (e.g., the first, the second and/or the third movement data measured) may provide or result in a weighting factor wa. Table 3 illustrates example time periods that may be used herein and example data and/or the like that may be provided therein.

TABLE 3

| Time | | |
|---|---|---|
| period | Example | Description |
| t₀-t₁ | 1 sec, 10 sec, 1 min | A time period before rendering |
| | | advertisement to the user (a first |
| | | time period). The motion data |
| | | collected during the first time period |
| | | may be the first movement data. |
| t₁-t₂ | 5 sec for pop up ad, 15 | A time period during which the |
| | sec for video add, 1 | advertisement may be visible or |
| | min for interactive | communicated (audio) to the user (a |
| | advertisement | second time period). The motion |
| | | data collected during the second time |
| | | may be the second movement data. |
| t₂-t₃ | 1 sec, 10 sec, 1 min | A time period after displaying the |
| | | advertisement to the user (a third |
| | | time period). The motion data |
| | | collected during the third time period |
| | | may be the third movement data. |

Based on advertisement content, the application 500, and/or other information (e.g., including the motion information), the advertisement that may be used may be adopted based on the analysis or during the analysis. For example, if the application may be for driving (e.g., a navigation application), the advertisement may be allowed to be displayed, for example, if or when it may be detected that there may be no motion (e.g., it is safe to take a look on the advertisement). According to another or additional example, if the application may be a game being played while holding the device (e.g., in hand), the advertisement may be displayed, for example, if or when it may be detected that the device may be held or actually in the hand (e.g., based on movement data or motion information).

In performing such an analysis, typical movement types of a user acting with the device in a normal manner may be detected (i.e. when using the device when the advertisement may not be shown to the person). As an example a movement type for the device can correlate on keeping the device in hand and watching it i.e. relatively stationary movement and stable orientation. According to an example, those moment types may be used for or when determining an effective pay per second times that may be used as basis for billing of the advertisement services as well as for revenue share of the advertisement revenues between the advertisement service provider 100 and the application developer of the application 500. If the movement type during viewing the advertisement differs from the typical movement type, the system (e.g., advertisement service) may determine or conclude that the advertisement was not observed.

Based on further examples, the core motion framework 506 may be configured to collect reference data to determine normal movement of the terminal during execution of the application 500 (e.g., the first movement data and the third movement data). In an example, the reference data may be used as a base line to determine whether there may be change in motion behavior of the device during the advertisement. This may be done or performed, for example, by comparing the second movement data with the first movement data and/or with the third movement data. Additionally, in an example, the first movement data and the third movement data may be compared to see if the advertisement may have had impact on the normal movement of the terminal.

According an example (e.g., as described herein), the motion data (e.g., the first, the second and/or the third movement data) related to an orientation of the device during the advertisement may be used as parameter to determine a weighting factor wa. For example, if in a normal operation (during at least one of the first or third time period) the device may be oriented in a landscape mode with 45 degrees tilt such that the device may be held by a user in his or her hand, but during the advertisement (during the second time period), the device may be tilted horizontally −45 degrees (i.e. maybe directed away from the user), the CPS billing analysis (e.g., the analysis) and/or the system described herein that may perform the analysis may determine that the advertisement may not have been seen by the user and wa may be set to 0 (or a smaller or nominal value). Additionally, for example, if first and/or third movement data (e.g., may indicate normal movement such as typical movement, and/or the like) and the second movement data during the display of the advertisement on the device may be the same or similar wa may be set to 1 or another suitable value (e.g., a value larger than the value determined when a user may not have seen the advertisement). As described herein, the cost per second (CPS) (e.g., or price per second) may be calculated by multiplying ta with wa (ta×wa) (e.g., by the application service). Additionally, the time that may be measured as described herein (e.g., during the method of FIG. 5A-5B) may be performed or done using a timer.

In an example, systems and/or methods for providing a cost per second advertisement model using a device may be provided in a website (e.g., and may include similar actions or functionalities with a browser application as described in FIG. 5A-5B with respect to an application). For example, a device or terminal may measure when the user may be browsing a web page. Then, an advertisement overlay may be displayed on top of the content of the web page and/or in a banner above the content. The advertisement overlay might be provided to the web browser, for example, as a Java script or as HTML5 content. In an example (e.g., after displaying the advertisement), second movement data may be measure during rendering or showing the advertisement to the user. The first movement data and the second movement data may be compared to determine weighting factor for the advertisement content as described herein.

As such, as an example, a user might be browsing in a web site having video content. During video content consumption, first movement data is collected. Showing an advertisement may interrupt the video. The second movement data may be collected during showing the advertisement. Further, third movement data may be collected after the advertisement and then first, second and third movement data may be compared.

According to or based on an example, the web site may include a portion or snippet of code that may be used to download Javascript®, and/or the like to an application that may be used to view the website such as a browser. An example portion or snippet of that may be used to implement an accelerometer reading (e.g., measure the first and/or second movement data) on an HTML page of the website may be shown below. The Java Script “readaccc.JS” may be called by the HTML code in an example.

```
<!DOCTYPE html>
<html>
<head>
  <title>Acceleration Example</title>
  <script type=“text/javascript” charset=“utf-8” src=“READACC.js”>
  </script>
  <script type=“text/javascript” charset=“utf-8”>
  // Wait for Script to load
  //
  document.addEventListener(“deviceready”, onDeviceReady, false);
  // Script may be ready
  //
  function onDeviceReady( ) {
    navigator.accelerometer.getCurrentAcceleration(onSuccess, onError);
  }
  // onSuccess: Get a snapshot of the current acceleration
  //
  function onSuccess(acceleration) {
    alert(‘Acceleration X: ’ + acceleration.x + ‘\n’ +
      ‘Acceleration Y: ’ + acceleration.y + ‘\n’ +
      ‘Acceleration Z: ’ + acceleration.z + ‘\n’ +
      ‘Timestamp: ’ + acceleration.timestamp + ‘\n’);
  }
  // onError: Failed to get the acceleration
  //
  function onError( ) {
    alert(‘onError!’);
  }
  </script>
</head>
<body>
  <h1>Example</h1>
  <p>getCurrentAcceleration</p>
</body>
</html>
```

The collected accelerometer data during showing of banner, pop-up, and/or other display area or type for the advertisement may be sent to advertisement service 100 via communication interface of the device and a network the device may be connected to via a communication link with the communication interface, for example, during the browsing.

According to an example, the price per second or cost per second (CPS) model that may be implemented in the systems and/or methods herein may be determined (e.g., the CPS billing price may be determined based on a timer and/or the movement data as described herein). For example, the measured time of displaying an advertisement ta (e.g., as described herein that may be measured with a timer) may be weighted by weighting factor wa (e.g., that may include the motion data during viewing or the first and/or second movement data). The price (e.g., for the CPS or price per second) that may be used for the shown advertisement may be generated or calculated as follows p=ta×wa. Such a price may be deducted from the advertisers account.

One or more use cases or implementations may be provided for the systems and/or methods for providing a price per second or CPS model for an advertisement. For example, the price per second or CPS model as described herein may be implemented or included in a platform such as Google®, Adwords . . . . For example, the platform could updated with methods and/or systems as described herein for cost per second or price per second that may detect or determine whether the video may be actually being watched. The platform may combine pricing of related to cost per view (CPV) with actual time of watching the advertisement to form hybrid model. For example, the hybrid model may be applied to banner, popup and in-app advertisement.

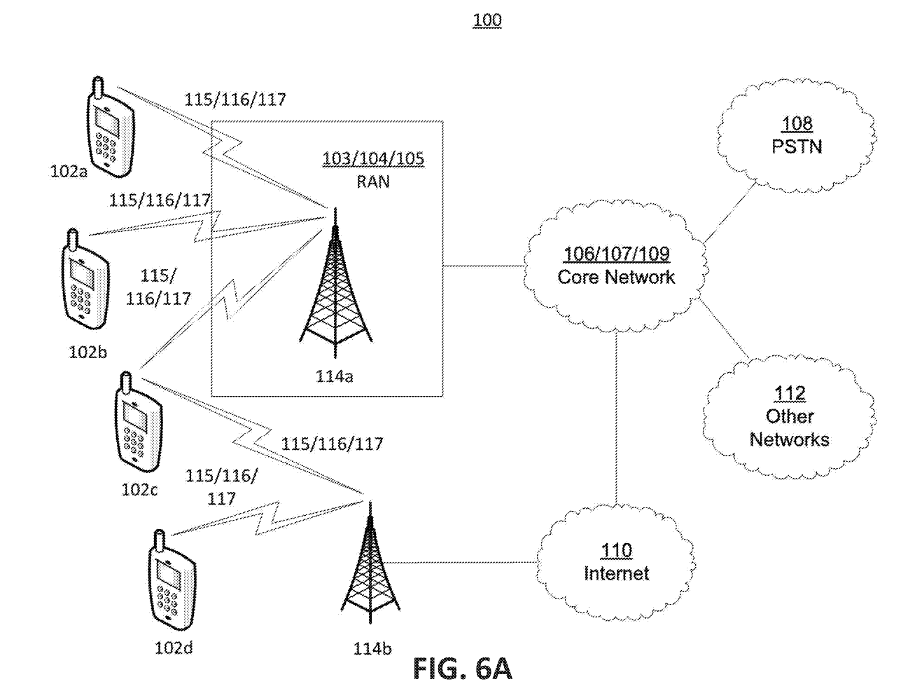

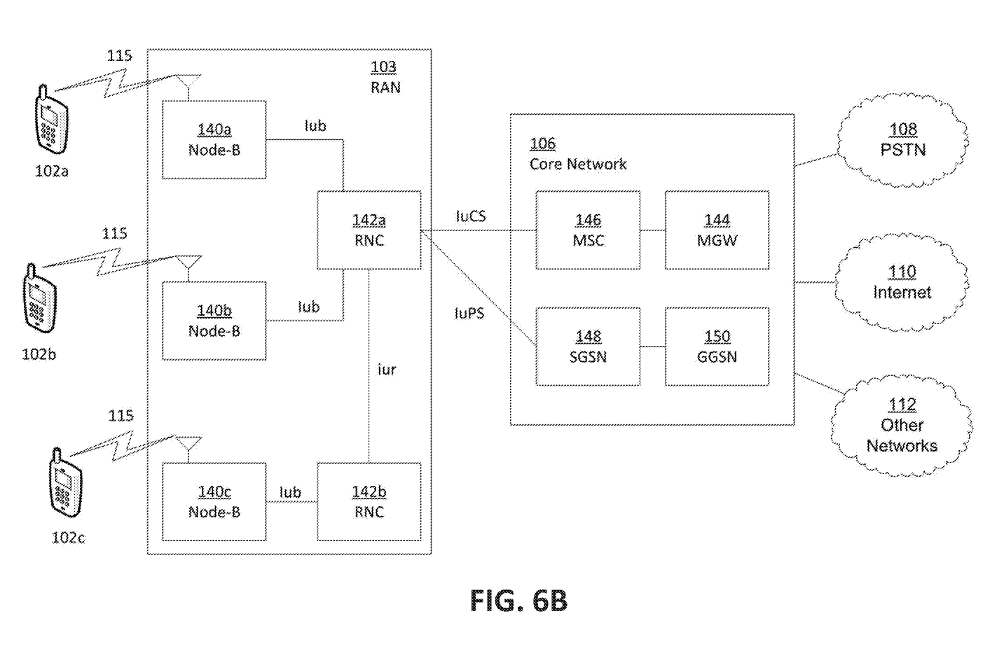

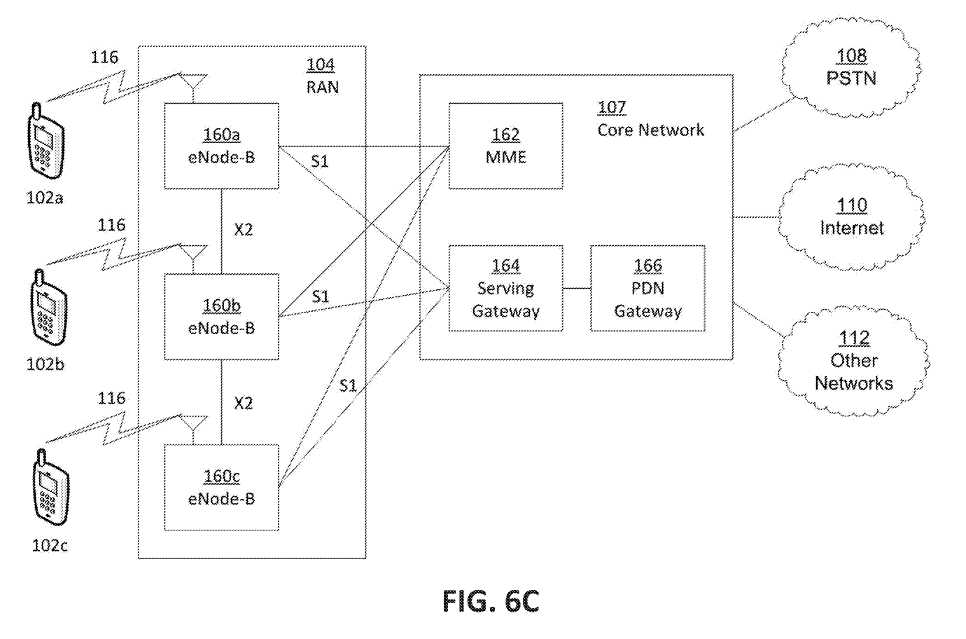

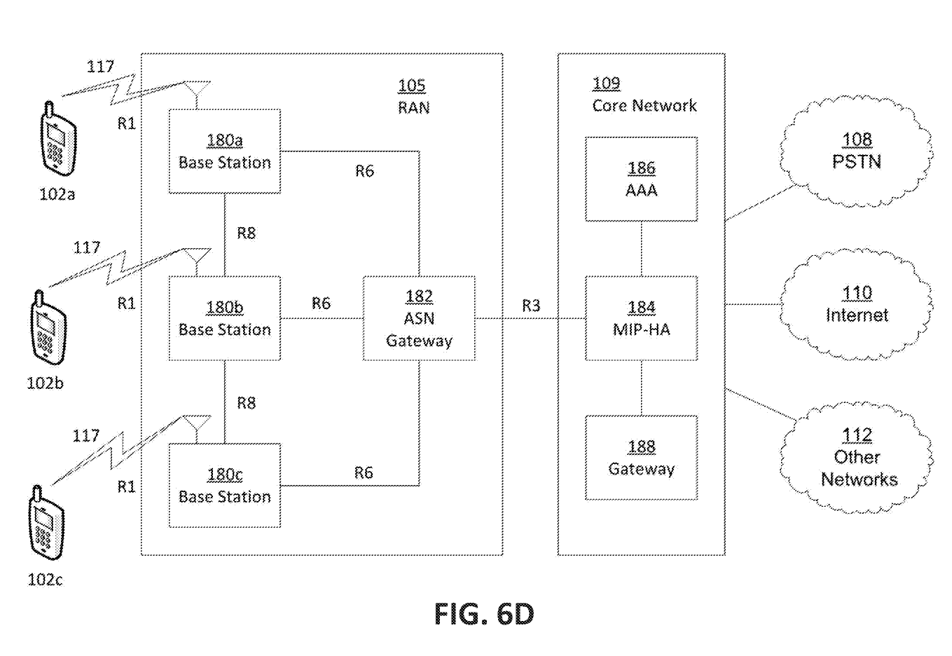

FIG. 6A depicts a diagram of an example communications system 600 in which one or more disclosed embodiments such as the example devices such as the wearable devices (e.g., smartwatches and/or smartglasses), a device in an automobile, and/or the like may be implemented. The communications system 600 may be a multiple access system that provides content, such as voice, data, video, messaging, broadcast, etc., to multiple wireless users. The communications system 600 may enable multiple wireless users to access such content through the sharing of system resources, including wireless bandwidth. For example, the communications systems 600 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 6A, the communications system 600 may include the devices 602a, 602b, 602c, and/or 602d (which generally or collectively may be referred to as device 602) that may include the devices described herein, a wireless transmit receive unit (WTRU), and/or any other device that may used with the system similar to the devices and/or a WTRU, a radio access network (RAN) 603/604/605, a core network 606/607/609, a public switched telephone network (PSTN) 608, the Internet 610, and other networks 612, though it will be appreciated that the disclosed embodiments contemplate any number of devices or WTRUs, base stations, networks, and/or network elements. Each of the devices 602a, 602b, 602c, and/or 602d may be any type of device configured to operate and/or communicate in a wireless environment. By way of example, the devices 602a. 602b, 602c, and/or 602d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, a wearable devices such as smartglasses, and/or the like.

The communications systems 600 may also include a base station 614a and a base station 614b. Each of the base stations 614a. 614b may be any type of device configured to wirelessly interface with at least one of the devices 602a, 602b, 602c, and/or 602d and/or the wearable device to facilitate access to one or more communication networks, such as the core network 606/607/609, the Internet 610, and/or the networks 612. By way of example, the base stations 614a and/or 614b may be a base transceiver station (BTS), a Node-B, an eNode B, a Home Node B, a Home eNode B, a site controller, an access point (AP), a wireless router, and the like. While the base stations 614a, 614b are each depicted as a single element, it will be appreciated that the base stations 614a, 614b may include any number of interconnected base stations and/or network elements.

The base station 614a may be part of the RAN 603/604/605, which may also include other base stations and/or network elements (not shown), such as a base station controller (BSC), a radio network controller (RNC), relay nodes, etc. The base station 614a and/or the base station 614b may be configured to transmit and/or receive wireless signals within a particular geographic region, which may be referred to as a cell (not shown). The cell may further be divided into cell sectors. For example, the cell associated with the base station 614a may be divided into three sectors. Thus, in one embodiment, the base station 614a may include three transceivers, i.e., one for each sector of the cell. In another embodiment, the base station 614a may employ multiple-input multiple output (MIMO) technology and, therefore, may utilize multiple transceivers for each sector of the cell.

The base stations 614a and/or 614b may communicate with one or more of the devices 602a, 602b, 602c, and/or 602d and/or the wearable device over an air interface 615/616/617, which may be any suitable wireless communication link (e.g., radio frequency (RF), microwave, infrared (IR), ultraviolet (UV), visible light, etc.). The air interface 615/616/617 may be established using any suitable radio access technology (RAT).

More specifically, as noted above, the communications system 600 may be a multiple access system and may employ one or more channel access schemes, such as CDMA, TDMA, FDMA. OFDMA, SC-FDMA, and the like. For example, the base station 614a in the RAN 603/604/605 and the devices 602a, 602b, and/or 602c and/or the wearable device may implement a radio technology such as Universal Mobile Telecommunications System (UMTS) Terrestrial Radio Access (UTRA), which may establish the air interface 615/616/617 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 614a and the devices 602a, 602b, and/or 602c and/or the wearable device may implement a radio technology such as Evolved UMTS Terrestrial Radio Access (E-UTRA), which may establish the air interface 615/616/617 using Long Term Evolution (LTE) and/or LTE-Advanced (LTE-A).

In other embodiments, the base station 614a and the devices 602a, 602b, and/or 602c and/or the wearable device may implement radio technologies such as IEEE 802.16 (i.e., Worldwide Interoperability for Microwave Access (WiMAX)). CDMA2000, CDMA2000 IX, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 614b in FIG. 6A may be a wireless router, Home Node B, Home eNode B. or access point, for example, and may utilize any suitable RAT for facilitating wireless connectivity in a localized area, such as a place of business, a home, a vehicle, a campus, and the like. In one embodiment, the base station 614b and the devices 602c, 602d and/or the wearable device may implement a radio technology such as IEEE 802.11 to establish a wireless local area network (WLAN). In another embodiment, the base station 614b and the devices 602c, 602d may implement a radio technology such as IEEE 802.15 to establish a wireless personal area network (WPAN). In yet another embodiment, the base station 614b and the devices 602c, 602d and/or the wearable device may utilize a cellular-based RAT (e.g., WCDMA, CDMA2000, GSM, LTE, LTE-A, etc.) to establish a picocell or femtocell. As shown in FIG. 6A, the base station 614b may have a direct connection to the Internet 610. Thus, the base station 614b may not be required to access the Internet 610 via the core network 606/607/609.

The RAN 603/604/605 may be in communication with the core network 606/607/609, which may be any type of network configured to provide voice, data, applications, and/or voice over internet protocol (VoIP) services to one or more of the devices 602a, 602b, 602c, and/or 602d and/or the wearable device. For example, the core network 606/607/609 may provide call control, billing services, mobile location-based services, pre-paid calling, Internet connectivity, video distribution, etc., and/or perform high-level security functions, such as user authentication. Although not shown in FIG. 6A, it may be appreciated that the RAN 603/604/605 and/or the core network 606/607/609 may be in direct or indirect communication with other RANs that employ the same RAT as the RAN 603/604/605 or a different RAT. For example, in addition to being connected to the RAN 603/604/605, which may be utilizing an E-UTRA radio technology, the core network 606/607/609 may also be in communication with another RAN (not shown) employing a GSM radio technology.

The core network 606/607/609 may also serve as a gateway for the devices 602a, 602b, 602c, and/or 602d and/or the wearable device to access the PSTN 608, the Internet 610, and/or other networks 612. The PSTN 608 may include circuit-switched telephone networks that provide plain old telephone service (POTS). The Internet 610 may include a global system of interconnected computer networks and devices that use common communication protocols, such as the transmission control protocol (TCP), user datagram protocol (UDP) and the internet protocol (IP) in the TCP/IP internet protocol suite. The networks 612 may include wired or wireless communications networks owned and/or operated by other service providers. For example, the networks 612 may include another core network connected to one or more RANs, which may employ the same RAT as the RAN 603/604/605 or a different RAT.

Some or all of the devices 602a, 602b, 602c, and/or 602d and/or the wearable device in the communications system 600 may include multi-mode capabilities, i.e., the devices 602a. 602b, 602c, and/or 602d and/or the wearable device may include multiple transceivers for communicating with different wireless networks over different wireless links. For example, the device 602c shown in FIG. 6A and/or the wearable device may be configured to communicate with the base station 614a, which may employ a cellular-based radio technology, and with the base station 614b, which may employ an IEEE 802 radio technology.

FIG. 6B depicts a system diagram of the RAN 603 and the core network 606 according to an embodiment. As noted above, the RAN 603 may employ a UTRA radio technology to communicate with the devices 602a, 602b, and/or 602c and/or the wearable interface over the air interface 615. The RAN 603 may also be in communication with the core network 606. As shown in FIG. 6B, the RAN 603 may include Node-Bs 640a, 640b, and/or 640c, which may each include one or more transceivers for communicating with the devices 602a, 602b, and/or 602c and/or the wearable device over the air interface 615. The Node-Bs 640a, 640b, and/or 640c may each be associated with a particular cell (not shown) within the RAN 603. The RAN 603 may also include RNCs 642a and/or 642b. It will be appreciated that the RAN 603 may include any number of Node-Bs and RNCs while remaining consistent with an embodiment.

As shown in FIG. 6B, the Node-Bs 640a and/or 640b may be in communication with the RNC 642a. Additionally, the Node-B 640c may be in communication with the RNC 642b. The Node-Bs 640a. 640b, and/or 640c may communicate with the respective RNCs 642a, 642b via an Iub interface. The RNCs 642a, 642b may be in communication with one another via an Iur interface. Each of the RNCs 642a. 642b may be configured to control the respective Node-Bs 640a, 640b, and/or 640c to which it is connected. In addition, each of the RNCs 642a, 642b may be configured to carry out or support other functionality, such as outer loop power control, load control, admission control, packet scheduling, handover control, macrodiversity, security functions, data encryption, and the like.

The core network 606 shown in FIG. 6B may include a media gateway (MGW) 644, a mobile switching center (MSC) 646, a serving GPRS support node (SGSN) 648, and/or a gateway GPRS support node (GGSN) 650. While each of the foregoing elements are depicted as part of the core network 606, it will be appreciated that any one of these elements may be owned and/or operated by an entity other than the core network operator.

The RNC 642a in the RAN 603 may be connected to the MSC 646 in the core network 606 via an IuCS interface. The MSC 646 may be connected to the MGW 644. The MSC 646 and the MGW 644 may provide the devices 602a. 602b, and/or 602c and/or the wearable device with access to circuit-switched networks, such as the PSTN 608, to facilitate communications between the devices 602a, 602b, and/or 602c and/or the wearable device and traditional land-line communications devices.

The RNC 642a in the RAN 603 may also be connected to the SGSN 648 in the core network 606 via an IuPS interface. The SGSN 648 may be connected to the GGSN 650. The SGSN 648 and the GGSN 650 may provide the devices 602a. 602b, and/or 602c and/or the wearable device with access to packet-switched networks, such as the Internet 610, to facilitate communications between and the devices 602a, 602b, and/or 602c and/or the wearable device and IP-enabled devices.

As noted above, the core network 606 may also be connected to the networks 612, which may include other wired or wireless networks that are owned and/or operated by other service providers.

FIG. 6C depicts a system diagram of the RAN 604 and the core network 607 according to an embodiment. As noted above, the RAN 604 may employ an E-UTRA radio technology to communicate with the devices 602a, 602b, and/or 602c and/or the wearable device over the air interface 616. The RAN 604 may also be in communication with the core network 607.

The RAN 604 may include eNode-Bs 660a, 660b, and/or 660c, though it will be appreciated that the RAN 604 may include any number of eNode-Bs while remaining consistent with an embodiment. The eNode-Bs 660a, 660b, and/or 660c may each include one or more transceivers for communicating with the devices 602a, 602b, and/or 602c and/or the wearable device over the air interface 616. In one embodiment, the eNode-Bs 660a. 660b, and/or 660c may implement MIMO technology. Thus, the eNode-B 660a, for example, may use multiple antennas to transmit wireless signals to, and receive wireless signals from, the device 602a and/or the wearable device.

Each of the eNode-Bs 660a, 660b, and/or 660c may be associated with a particular cell (not shown) and may be configured to handle radio resource management decisions, handover decisions, scheduling of users in the uplink and/or downlink, and the like. As shown in FIG. 6C, the eNode-Bs 660a, 660b, and/or 660c may communicate with one another over an X2 interface.

The core network 607 shown in FIG. 6C may include a mobility management gateway (MME) 662, a serving gateway 664, and a packet data network (PDN) gateway 666. While each of the foregoing elements are depicted as part of the core network 607, it will be appreciated that any one of these elements may be owned and/or operated by an entity other than the core network operator.

The MME 662 may be connected to each of the eNode-Bs 660a. 660b, and/or 660c in the RAN 604 via an S1 interface and may serve as a control node. For example, the MME 662 may be responsible for authenticating users of the devices 602a, 602b, and/or 602c and/or the wearable device, bearer activation/deactivation, selecting a particular serving gateway during an initial attach of the devices 602a, 602b, and/or 602c and/or the wearable device, and/or the like. The MME 662 may also provide a control plane function for switching between the RAN 604 and other RANs (not shown) that employ other radio technologies, such as GSM or WCDMA.

The serving gateway 664 may be connected to each of the eNode-Bs 660a, 660b, and/or 660c in the RAN 604 via the S1 interface. The serving gateway 664 may generally route and forward user data packets to/from the devices 602a, 602b, and/or 602c and/or the wearable device. The serving gateway 664 may also perform other functions, such as anchoring user planes during inter-eNode B handovers, triggering paging when downlink data is available for the devices 602a. 602b, and/or 602c and/or the wearable device, managing and storing contexts of the devices 602a, 602b, and/or 602c and/or the wearable device, and/or the like.

The serving gateway 664 may also be connected to the PDN gateway 666, which may provide the devices 602a, 602b, and/or 602c and/or the wearable device with access to packet-switched networks, such as the Internet 610, to facilitate communications between the devices 602a. 602b, and/or 602c and/or the wearable device and IP-enabled devices.

The core network 607 may facilitate communications with other networks. For example, the core network 607 may provide the devices 602a. 602b, and/or 602c and/or the wearable device with access to circuit-switched networks, such as the PSTN 608, to facilitate communications between the devices 602a, 602b, and/or 602c and/or the wearable device and traditional land-line communications devices. For example, the core network 607 may include, or may communicate with, an IP gateway (e.g., an IP multimedia subsystem (IMS) server) that serves as an interface between the core network 607 and the PSTN 608. In addition, the core network 607 may provide the devices 602a, 602b, and/or 602c and/or the wearable device with access to the networks 612, which may include other wired or wireless networks that are owned and/or operated by other service providers.

FIG. 6D depicts a system diagram of the RAN 605 and the core network 609 according to an embodiment. The RAN 605 may be an access service network (ASN) that employs IEEE 802.16 radio technology to communicate with the devices 602a, 602b, and/or 602c and/or the wearable device over the air interface 617. As will be further discussed below, the communication links between the different functional entities of the devices 602a, 602b, and/or 602c and/or the wearable device, the RAN 605, and the core network 609 may be defined as reference points.

As shown in FIG. 6D, the RAN 605 may include base stations 680a, 680b, and/or 680c, and an ASN gateway 682, though it will be appreciated that the RAN 605 may include any number of base stations and ASN gateways while remaining consistent with an embodiment. The base stations 680a, 680b, and/or 680c may each be associated with a particular cell (not shown) in the RAN 605 and may each include one or more transceivers for communicating with the devices 602a, 602b, and/or 602c and/or the wearable device over the air interface 617. In one embodiment, the base stations 680a, 680b, and/or 680c may implement MIMO technology. Thus, the base station 680a, for example, may use multiple antennas to transmit wireless signals to, and receive wireless signals from, the device 602a and/or the wearable device. The base stations 680a, 680b, and/or 680c may also provide mobility management functions, such as handoff triggering, tunnel establishment, radio resource management, traffic classification, quality of service (QoS) policy enforcement, and the like. The ASN gateway 682 may serve as a traffic aggregation point and may be responsible for paging, caching of subscriber profiles, routing to the core network 609, and the like.

The air interface 617 between the devices 602a, 602b, and/or 602c and/or the wearable device and the RAN 605 may be defined as an R1 reference point that implements the IEEE 802.16 specification. In addition, each of the devices 602a, 602b, and/or 602c and/or the wearable device may establish a logical interface (not shown) with the core network 609. The logical interface between the devices 602a, 602b, and/or 602c and/or the wearable device and the core network 609 may be defined as an R2 reference point, which may be used for authentication, authorization, IP host configuration management, and/or mobility management.

The communication link between each of the base stations 680a, 680b, and/or 680c may be defined as an R8 reference point that includes protocols for facilitating device or WTRU handovers and the transfer of data between base stations. The communication link between the base stations 680a, 680b, and/or 680c and the ASN gateway 682 may be defined as an R6 reference point. The R6 reference point may include protocols for facilitating mobility management based on mobility events associated with each of the devices 602a, 602b, and/or 602c and/or the wearable device.

As shown in FIG. 6D, the RAN 605 may be connected to the core network 609. The communication link between the RAN 605 and the core network 609 may defined as an R3 reference point that includes protocols for facilitating data transfer and mobility management capabilities, for example. The core network 609 may include a mobile IP home agent (MIP-HA) 684, an authentication, authorization, accounting (AAA) server 686, and a gateway 688. While each of the foregoing elements are depicted as part of the core network 609, it will be appreciated that any one of these elements may be owned and/or operated by an entity other than the core network operator.

The MIP-HA may be responsible for IP address management, and may enable the devices 602a, 602b, and/or 602c and/or the wearable device to roam between different ASNs and/or different core networks. The MIP-HA 684 may provide the devices 602a, 602b, and/or 602c and/or the wearable device with access to packet-switched networks, such as the Internet 610, to facilitate communications between the devices 602a. 602b, and/or 602c and/or the wearable device and IP-enabled devices. The AAA server 686 may be responsible for user authentication and for supporting user services. The gateway 688 may facilitate interworking with other networks. For example, the gateway 688 may provide the devices 602a. 602b, and/or 602c and/or the wearable device with access to circuit-switched networks, such as the PSTN 608, to facilitate communications between the devices 602a. 602b, and/or 602c and/or the wearable device and traditional land-line communications devices. In addition, the gateway 688 may provide the devices 602a, 602b, and/or 602c and/or the wearable device with access to the networks 612, which may include other wired or wireless networks that are owned and/or operated by other service providers.

Although not shown in FIG. 6D, it should, may, and/or will be appreciated that the RAN 605 may be connected to other ASNs and the core network 609 may be connected to other core networks. The communication link between the RAN 605 the other ASNs may be defined as an R4 reference point, which may include protocols for coordinating the mobility of the devices 602a, 602b, and/or 602c and/or the wearable device between the RAN 605 and the other ASNs. The communication link between the core network 609 and the other core networks may be defined as an R5 reference, which may include protocols for facilitating interworking between home core networks and visited core networks.

Although the terms device, system, terminal, and/or the like may be used herein, it may and should be understood that the use of such terms may be used interchangeably and, as such, may not be distinguishable. Further, although the terms motion data, movement data, and/or the like may be used herein, it may and should be understood that the use of such terms may be used interchangeably and, as such, may not be distinguishable. Additionally, although the terms motion, movement, and/or the like may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-16. (canceled)

17. A device comprising:
a transmitter adapted to wirelessly transmit data;
a display unit;
one or more motion sensors;
a computing processor communicatively coupled with the transmitter, display unit, and one or more motion sensors; and
a memory communicatively coupled with the computing processor, the memory having stored thereon executable instructions that when executed cause the device to:
determine, using the one or more motion sensors, first movement data associated with handling of the device while a first content item is displayed on the display unit;
display, by the display unit and after the first movement data is determined, a second content item;
determine, using the one or more motion sensors, second movement data during the display of the second content item; and
send, using the transmitter, the first movement data and the second movement data to a network entity, wherein the first movement data and the second movement data are capable of being used to determine a degree to which the second content item was observed by a user based at least in part on a degree of similarity between the first movement data and the second movement data.

18. The device of claim 17, wherein the first movement data and the second movement data comprise data identifying at least one of orientation or motion of the device.

19. The device of claim 17,
wherein the first movement data corresponds to a base line of movement associated with the device; and
wherein the second movement data reflects a change in motion of the device from the base line.

20. The device of claim 17,
wherein the first content item is associated with a first application, and
wherein the second content item is associated with the first application.

21. The device of claim 17,
wherein the first content item is associated with a first application, and
wherein the second content item is not associated with the first application.

22. The device of claim 17, the memory further having stored thereon instructions that when executed cause the device to:
measure a time associated with displaying the second content item; and
send the measured time associated with displaying the second content item.

23. The device of claim 22, wherein the executable instructions that when executed cause the device to measure the time associated with displaying the content item comprise executable instructions that cause the device to:
start a timer upon beginning to display the second content item; and
stop the timer upon ceasing to display the second content item.

24. The device of claim 17, the memory further having stored thereon instructions that when executed cause the device to:
determine third movement data after display of the second content item is ceased; and
send the third movement data to the network entity, wherein the first movement data, the second movement data, and the third movement data are capable of being used to determine a degree to which the second content item was observed by the user based at least in part on a degree of similarity between the first movement data, the second movement data, and the third movement data.

25. A method for determining attentiveness to content displayed on a device, comprising:
determining, by a device, first movement data associated with handling of the device while a first content item is displayed on the device;
displaying, by the device and after determining the first movement data, a second content item;
determining, by the device, second movement data during the display of the second content item; and
sending, by the device, the first movement data and the second movement data to a network entity, wherein the first movement data and the second movement data are capable of being used to determine a degree to which the second content item was observed by a user based at least in part on a degree of similarity between the first movement data and the second movement data.

26. The method of claim 25,
wherein the first movement data and the second movement data comprise data identifying at least one of orientation or motion of the device.

27. The method of claim 25,
wherein the first movement data corresponds to a base line of movement associated with the device; and
wherein the second movement data reflects a change in motion of the device from the base line.

28. The method of claim 25,
wherein the first content item is associated with a first application, and
the second content item is associated with the first application.

29. The method of claim 25,
wherein the first content item associated with a first application, and
wherein the second content item is not associated with the first application.

30. The method of claim 25, further comprising:
measuring, by the device, a time associated with displaying the second content item; and
sending, by the device, the measured time associated with displaying the second content item.

31. The method of claim 30, wherein measuring the time associated with displaying the second content item comprises:
starting a timer upon beginning to display the second content item; and
stopping the timer upon ceasing to display the second content item.

32. The method of claim 25, further comprising:
determining, by the device, third movement data after ceasing display of the second content item; and
sending, by the device, the third movement data to the network entity, wherein the first movement data, the second movement data, and the third movement data are capable of being used to determine a degree to which the second content item was observed by the user based at least in part on a degree of similarity between the first movement data, the second movement data, and the third movement data.

33. A device comprising:
a receiver adapted to wirelessly receive data;
a computing processor communicatively coupled with the receiver; and
a memory communicatively coupled with the computing processor, the computing memory having stored thereon executable instructions that when executed cause the device to:
receive first movement data associated with handling of a device while a first content item is displayed on the device;
receive second movement data associated with display of a second content item on the device after the first movement data is determined; and
determine a degree to which the second content item was observed by a user based at least in part on a degree of similarity between the first movement data and the second movement data.

34. The device of claim 33,
wherein the executable instructions that when executed cause the device to determine the degree to which the second content item was observed by the user comprise executable instructions that cause the device to:
determine, based at least on the first movement data and the second movement data, a movement type associated with the device;
determine, based at least upon the movement type, a value representing a measure of the degree to which the second content item was observed by the user.

35. The device of claim 34,
wherein the executable instructions that when executed cause the device to determine a movement type comprise executable instructions that cause the device to:
determine a movement type associated with the second movement data is different than a movement type associated with the first movement data.

36. The device of claim 33, the memory further having stored thereon instructions that when executed cause the device to:
receive timer data indicating a length of time the second content item was displayed on the device; and
determine a weighted length of time by multiplying the length of time the second content item was displayed on the device by the value representing the degree to which the second content item was observed by the user.
